(19) United States
(12) Patent Application Publication
(10) Pub. No.: US 2023/0367527 A1
(43) Pub. Date: Nov. 16, 2023

(54) METHODS AND SYSTEMS FOR LINKING MULTI-FUNCTION PRINTERS AND BAR-CODE PRINTERS

(71) Applicant: TOSHIBA TEC KABUSHIKI KAISHA, Shinagawa-ku (JP)

(72) Inventors: Hariharasudhan SRINIVASAN, Bangalore (IN); Vishal KASETTY, Bangalore (IN); Tamil MANI, Bangalore (IN)

(73) Assignee: TOSHIBA TEC KABUSHIKI KAISHA, Shinagawa-ku (JP)

(21) Appl. No.: 18/097,745

(22) Filed: Jan. 17, 2023

(30) Foreign Application Priority Data
May 16, 2022 (IN) 202241028065

(51) Int. Cl. G06F 3/12

(52) U.S. Cl. CPC G06F 3/1247; G06F 3/1204

(57) ABSTRACT

A method is provided for linking Multi-Function Printers (MFPs) and Bar-Code Printers (BCPs). When the BCP is in a non-functional mode and the BCP receives a command file to be printed, the BCP cannot print the command file. In such scenario, the BCP converts the file to a predefined format understandable by the MFP and sends the file to the MFP over a predetermined communication channel. The MFP prints the requested file. When the BCP receives a command file to be printed in a format not understandable by BCP, the BCP cannot print the command file as the command file. Thus, the BCP sends the command file to the MFP and the MFP converts the command file to a data file in a format understandable by BCP and returns it to the BCP. The BCP prints the data file.

### CROSS-REFERENCE TO RELATED PATENT APPLICTION

This application claims the benefit of and priority to IN Patent Application No. 202241028065, filed May 16, 2022, which is incorporated herein by reference in its entirety.

### TECHNICAL FIELD

The present disclosure generally relates to Multi-Function Printers (MFPs). More particularly, the present disclosure relates to methods and systems for linking MFPs and Bar-Code Printers (BCPs).

### BACKGROUND

A Bar-Code Printer or BCP is a device used for printing barcode labels or tags that can be attached to, or printed directly on, physical objects. BCPs are commonly used to label cartons before shipment, or to label retail items. There might be issues in BCP while printing, for example, issues like a broken print head, unavailability of a thermal roll, unavailability of ribbons, etc., due to which the BCP becomes unavailable for label printing.

Another issue with the BCPs is a mismatch in the format of data files received by the BCPs for printing. Typically, the BCP can receive a file to be printed in a format not understandable by the BCP, such as Page Description Language (PDL) format, Printer Control Language (PCL) format, PostScript (PS), XML Paper Specification (XPS) or Portable Document Format (PDF) format. In these scenarios, the BCP cannot print the requested file.

Thus, it is desirable to have a BCP that is reliable and overcomes certain limitations in existing BCPs.

The information disclosed in this background of the disclosure section is only for enhancement of understanding of the general background of the present disclosure and should not be taken as an acknowledgement or any form of suggestion that this information forms the prior art already known to a person skilled in the art.

### SUMMARY

Disclosed herein is a method for linking Bar-Code Printers (BCPs) with Multi-Function Printers (MFPs). The method comprises determining, by a BCP, when the BCP is in a non-functional mode, when the BCP receives a command file to be printed. Further, the method comprises creating an image, corresponding to the command file to be printed, in a format understandable by one or more MFPs. Finally, the method comprises sharing the image to the one or more MFPs for printing.

Further, the present disclosure relates to a Bar-Code Printer (BCP) which can be linked with Multi-Function Printers (MFPs). The BCP comprises a processor and a memory. The memory is communicatively coupled to the processor and stores processor-executable instructions, which on execution, cause the processor to determine when the BCP is in a non-functional mode, when the BCP receives a command file to be printed. Further, the instructions cause the processor to create an image, corresponding to the command file to be printed, in a format understandable by one or more MFPs. Finally, the instructions cause the processor to share the image to the one or more MFPs for printing.

Furthermore, the present disclosure relates to a non-transitory computer readable medium including instructions stored thereon that when processed by at least one processor, cause a Bar-Code Printer (BCP) to perform operations comprising determining when the BCP is in a non-functional mode, when the BCP receives a command file to be printed. Further, the instructions cause the processor to create an image, corresponding to the command file to be printed, in a format understandable by one or more MFPs. Finally, the instructions cause the processor to share the image to the one or more MFPs for printing.

Furthermore, the present disclosure discloses a method for linking Bar-Code Printers (BCPs) and Multi-Function Printers (MFPs). The method comprises receiving, by a MFP, a command file to be printed, from the BCP, when the BCP receives the command file in a format not recognizable by the BCP. Further, the method comprises converting the command file to a data file in a format understandable by the BCP. Finally, the method comprises sending the data file to the BCP for printing.

Further, the present disclosure relates to Bar-Code Printers (BCPs) which can be linked with a Multi-Function Printer (MFP). The MFP comprises a processor and a memory. The memory is communicatively coupled to the processor and stores processor-executable instructions, which on execution, cause the processor to receive a command file to be printed, from the BCP, when the BCP receives the command file in a format not recognizable by the BCP. Further, the instructions cause the processor to convert the command file to a data file in a format understandable by the BCP. Finally, the instructions cause the processor to send the data file to the BCP for printing.

Furthermore, the present disclosure relates to a non-transitory computer readable medium including instructions stored thereon that when processed by at least one processor, cause a Multi-Function Printer (MFP) to perform operations comprising receiving a command file to be printed, from the BCP, when the BCP receives the command file in a format not recognizable by the BCP. Further, the instructions cause the processor to convert the command file to a data file in a format understandable by the BCP. Finally, the instructions cause the processor to send the data file to the BCP for printing.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1A and FIG. 1B show an exemplary illustration of linking Bar-Code Printer (BCP) and Multi-Function Printer (MFP), in accordance with some embodiments of the present disclosure.

FIG. 2A shows a detailed block diagram of a Bar-Code Printer (BCP), in accordance with some embodiments of the present disclosure.

FIG. 2B shows a detailed block diagram of a Multi-Function Printer (MFP), in accordance with some embodiments of the present disclosure.

FIG. 3A and FIG. 3B show a flowchart illustrating a method for linking Multi-Function Printers (MFPs) and Bar-Code Printers (BCPs), in accordance with some embodiments of the present disclosure.

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, a specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method of linking a Bar-Code Printer (BCP) and one or more Multi-Function Printers (MFPs). In an embodiment, when the BCP receives a command file to be printed from a user when the BCP is in a non-functional condition, the BCP cannot print the command file. As an example, the non-functional mode can be at least one of a paper out condition, a ribbon out condition and a print head error. In such scenarios, the BCP may forward the command file to one or more MFPs, which are ready/functional and capable of printing the command file. In an embodiment, before transmitting the command file to the MFP, the BCP may provide an alert to the user on the display panel of the BCP or any other computing system associated with the user. The user may be allowed to either accept or reject the alert. In an embodiment, if the user does not want to send the command file to the MFP for printing, then the user may reject the alert. In this case, the user may try to rectify the non-functionality of the BCP and try to print. Alternatively, if the user wants to send the file to the MFP for printing, then the user may accept the alert and the BCP may create an image file corresponding to the command file, in a predefined image file format, which is understandable by the MFPs. As an example, the predefined image file format may be Bitmap (BMP) image file format. Further, the image created by the BCP may be shared with the MFPs and the MFPs may print the image (i.e., command file) on behalf of the BCP.

In another embodiment, suppose the BCP receives a command file in a format that is not recognizable by the BCP. In this scenario, the BCP sends the command file to the MFP. As an example, the format not recognizable by the BCP can be at least one of Page Description Language (PDL) format, Printer Control Language (PCL) format, PostScript (PS), XML Paper Specification (XPS) or Portable Document Format (PDF) format. The MFP receives the command file from the BCP and converts the command file to a data file which is in a predefined image file format recognizable by the BCP. As an example, the predefined image file format may be Bitmap (BMP) image file format. Finally, the data file created by the MFP may be sent to the BCP for printing.

In an embodiment, the proposed method aims to link the functionalities of both the Bar-Code Printers (BCPs) and the Multi-Function Printers (MFPs) for completing the required job even when the BCP is in a non-functional mode or when the BCP receives a command file to be printed in the format not understandable by the BCP. Linking both the printers aids in both the scenarios mentioned above. Also, with the proposed solution, the label images, which are usually printed in the BCP, can be printed with the MFP.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

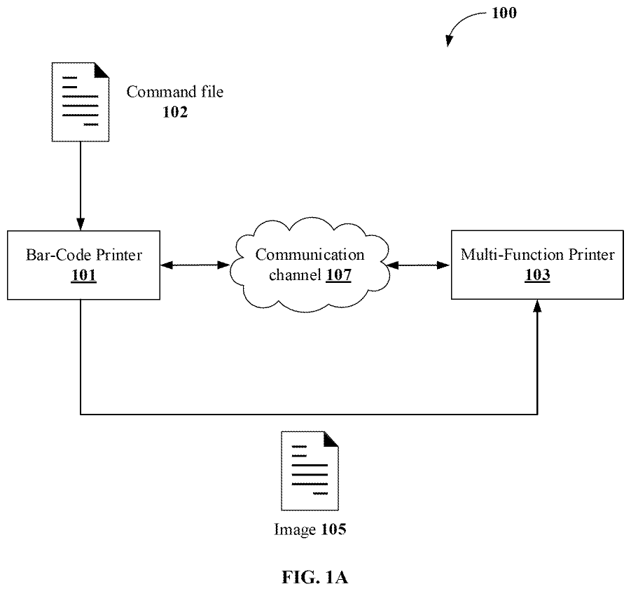

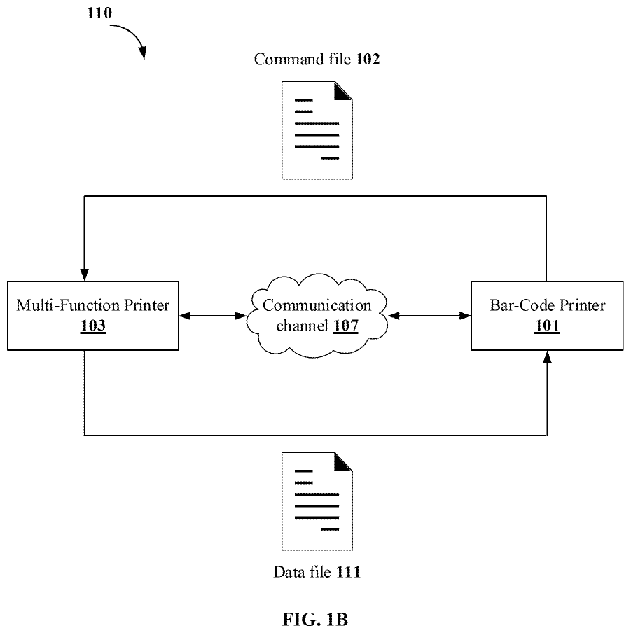

FIG. 1A shows an exemplary illustration of linking Bar-Code Printer (BCP) and Multi-Function Printer (MFP), in accordance with some embodiments of the present disclosure.

In an embodiment, a Bar-Code Printer 101 (BCP) and a Multi-Function Printer 103 (MFP) are connected using a predetermined communication channel 107. For example, the predetermined communication channel 107 can be any type of a wired or a wireless connection. In an embodiment, the BCP 101 may receive a command file 102 to be printed from a user of the BCP 101. When the command file 102 is received, if the BCP 101 is in a non-functional mode, the BCP 101 cannot print the command file 102. As an example, the non-functional mode can be at least one of a paper out condition, a ribbon out condition and a print head error. In the above scenario, consider that the MFP 103 connected with the BCP 101 is ready/functional and capable of printing the command file 102. The user may get an option to send the command file 102 to the MFP 103 for printing. If the user selects an option to not send the command file 102, then the command file 102 is not shared with the MFP 103. Alternatively, if the user wants to send the command file 102 to the MFP 103 for printing, then the BCP 101 may create and/or convert the command file 102 into an image 105 which is in a predefined image file format understandable by the MFP 103. As an example, the predefined image file format may be Bitmap (BMP) image file format. After converting the command file 102, the BCP transmits the image 105 to the MFP 103 over the predetermined communication channel 107. The MFP 103 receives the image 105 and prints the image 105, thereby completing the printing job on behalf of the BCP. In an embodiment, the image 105 printed by the MFP 103 may be verified by scanning the printed image using an MFP scanner, which will validate the barcodes in the image printed by the MFP.

FIG. 1B shows an exemplary illustration of linking Bar-Code Printer (BCP) and Multi-Function Printer (MFP), in accordance with some embodiments of the present disclosure.

In an embodiment, FIG. 1B illustrates an alternative embodiment and/or use case of connecting the BCP 101 and the MFP 103. In an embodiment, suppose, the BCP 101 receives a command file 102, but the format of the command file 102 is not understandable by the BCP 101. As an example, the formats not recognizable by BCP 101 can be at least one of Page Description Language (PDL) format, Printer Control Language (PCL) format, PostScript (PS), XML Paper Specification (XPS) or Portable Document Format (PDF) format. In the scenario, the BCP 101 may send the command file 102 to the MFP 103 over the predetermined communication channel 107. The MFP may convert the command file 102 to a format understandable by the BCP 101.

In an embodiment, the MFP 103 may convert the command file 102 to a data file 111 in a predefined image file format understandable by the BCP 101. For example, the predefined image file format can be Bitmap (BMP) image file format. In an embodiment, the data file 111 may be sent to the BCP 101 over the predetermined communication channel 107. The BCP 101 receives the data file 111 sent by the MFP 103 and prints the data file 111 automatically with required machine settings like number of copies, direct print, thermal print etc., that are set by a user.

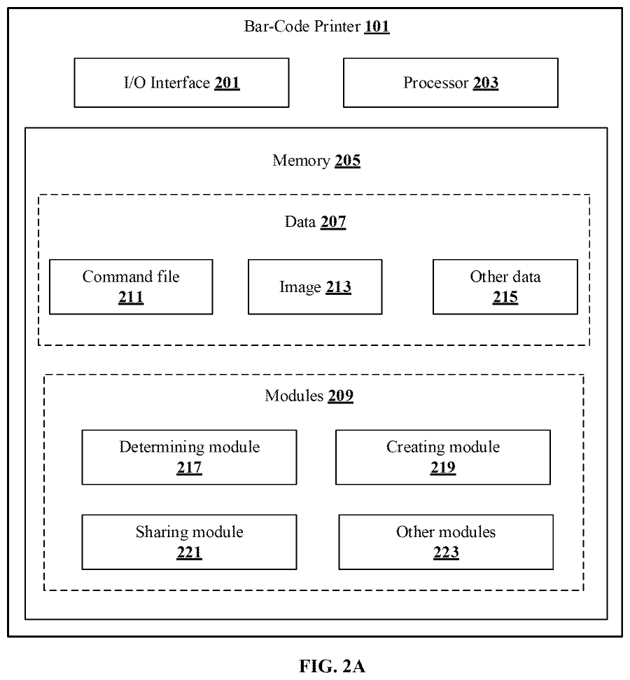

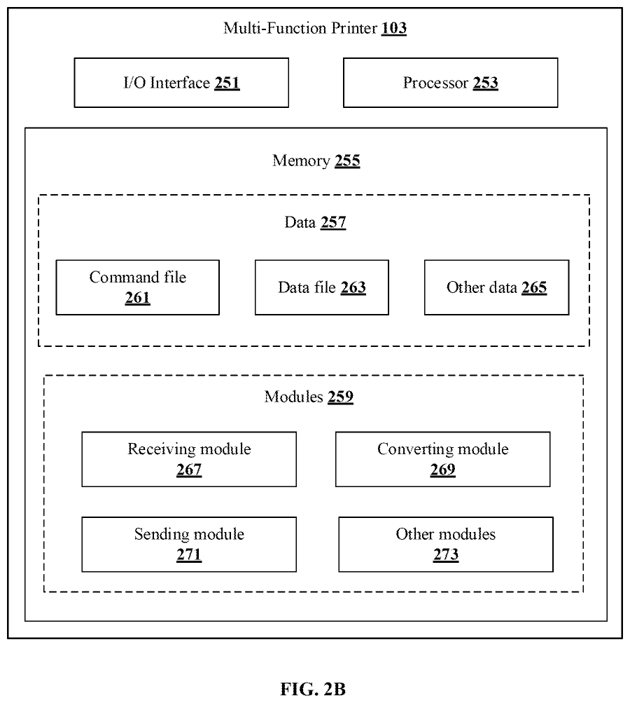

FIG. 2A shows a detailed block diagram of a Bar-Code Printer (BCP) 101 in accordance with some embodiments of the present disclosure.

In an embodiment, the Bar-Code Printer (BCP) 101 may include an input/output (I/O) interface 201, a processor 203 and a memory 205. The I/O interface 201 may be used for receiving one or more user inputs from a user using the BCP 101. For example, the one or more user inputs may be files to be printed, number of copies to be printed and the like. The processor 203 may be configured to perform one or more functions of the BCP 101, using the data 207 and the one or more modules 209 in stored in a memory 205 of the BCP 101. In an embodiment, the memory 205 may store data 207 and one or more modules 209.

In an embodiment, the data 207 stored in the memory 205 may include, without limitation, a command file 211, an image 213 and other data 215. In some implementations, the data 207 may be stored within the memory 205 in the form of various data structures. Additionally, the data 207 may be organized using data models, such as relational or hierarchical data models. The other data 215 may include various temporary data and files generated by the one or more modules 209.

In an embodiment, the command file 211 may be the file to be printed by the BCP. In an embodiment, the command file 211 is in the format understandable by BCP 101. For example, the format can be Toshiba Printer Command Language (TPCL).

In an embodiment, the image 213 may be the file converted by the BCP in the predefined image file format understandable by MFP 103. For example, the predefined image file format understandable by the MFP 103 is Bitmap (BMP) image file format.

In an embodiment, the data 207 may be processed by the one or more modules 209 of the BCP 101. In some implementations, the one or more modules 209 may be communicatively coupled to the processor 203 for performing one or more functions of the BCP 101. In an implementation, the one or more modules 209 may include, without limiting to, a determining module 217, a creating module 219, a sharing module 221 and other modules 223.

As used herein, the term module may refer to an Application Specific Integrated Circuit (ASIC), an electronic circuit, a hardware processor (shared, dedicated, or group) and memory that execute one or more software or firmware programs, a combinational logic circuit, and/or other suitable components that provide the described functionality. In an implementation, each of the one or more modules 209 may be configured as stand-alone hardware computing units. In an embodiment, the other modules 223 may be used to perform various miscellaneous functionalities of the BCP 101. It will be appreciated that such one or more modules 209 may be represented as a single module or a combination of different modules.

In an embodiment, the determining module 217 may be configured for determining when the BCP is in a non-functional mode. In an embodiment, the creating module 219 may be configured for creating an image, corresponding to the command file to be printed, in a format understandable by one or more MFPs. In an embodiment, the sharing module 221 may be configured for sharing the image to the one or more MFPs for printing.

In an embodiment, the determining module 217 determines when the BCP 101 is in a non-functional mode. For example, the non-functional mode can be at least one of a paper out condition, a ribbon out condition and a print head error. Since the BCP is non-functional, the command file cannot be printed by the BCP. In an embodiment, the determining module 217 may notify the mode of the BCP 101, i.e., whether the BCP is functional or non-functional, to the user of the BCP, so that the user can rectify the error due to which the BCP 101 is in the non-functional mode.

In an embodiment, the creating module 219 creates an image 213 of the command file to be printed, in a format understandable by one or more MFPs 103. As mentioned above, if the BCP 101 is in non-functional mode, the command file 211 can be printed by the MFP 103, but the command file must be in a format understandable by the MFP 103. Therefore, the creating module 219 creates an image 213 of the command file 211 in a predefined image file format understandable by the MFP 103. As an example, the predefined image file format can be Bitmap (BMP) image file format.

In an embodiment, the sharing module 221 shares the image 213 created by the BCP 101 using a predetermined communication channel 107. For example, the predetermined communication channel 107 can be any type of a wired or a wireless connection. FIG. 2B shows a detailed block diagram of a Multi-Function Printer (MFP) 103 in accordance with some embodiments of the present disclosure.

In an embodiment, the Multi-Function Printer (MFP) 103 may include an I/O interface 251, a processor 253 and a memory 255. The I/O interface 251 may be used for receiving one or more user inputs from a user using the BCP 101. For example, the one or more user inputs may be files to be printed, number of copies etc. The processor 253 may be configured to perform one or more functions of the MFP 103 using the data 257 and the one or more modules 259 stored in a memory 255 of the MFP 103. In an embodiment, the memory 255 may store data 257 and one or more modules 259.

In an embodiment, the data 257 stored in the memory 255 may include, without limitation, one or more command file 261, a data file 263 and other data 265. In some implementations, the data 257 may be stored within the memory 255 in the form of various data structures. Additionally, the data 257 may be organized using data models, such as relational or hierarchical data models. The other data 265 may include various temporary data and files generated by the one or more modules 259.

In an embodiment, the one or more command file 261 may be the file received from the BCP 101 and to be converted by the MFP 103. In an embodiment, the command file 261 is in the format not understandable by BCP 101. For example, the format can be at least one of Page Description Language (PDL) format, Printer Control Language (PCL) format, PostScript (PS), XML Paper Specification (XPS) or Portable Document Format (PDF) format.

In an embodiment, the one or more data file 263 may be the file converted by the MFP 103 in the predefined image file format understandable by BCP 101. For example, the predefined image file format understandable by BCP 101 is Bitmap (BMP) image file format.

In an embodiment, the data 257 may be processed by the one or more modules 259 of the MFP 103. In some implementations, the one or more modules 259 may be communicatively coupled to the processor 253 for performing one or more functions of the MFP 103. In an implementation, the one or more modules 259 may include, without limiting to, a receiving module 267, a converting module 269, a sending module 271 and other modules 273.

As used herein, the term module may refer to an Application Specific Integrated Circuit (ASIC), an electronic circuit, a hardware processor (shared, dedicated, or group) and memory that execute one or more software or firmware programs, a combinational logic circuit, and/or other suitable components that provide the described functionality. In an implementation, each of the one or more modules 259 may be configured as stand-alone hardware computing units. In an embodiment, the other modules 273 may be used to perform various miscellaneous functionalities of the MFP 103. It will be appreciated that such one or more modules 259 may be represented as a single module or a combination of different modules.

In an embodiment, the receiving module 267 may be configured for receiving a command file to be printed, from the BCP 101, when the BCP 101 receives the command file in a format not recognizable by the BCP 101. In an embodiment, the converting module 269 may be configured for converting the command file to a data file in a format understandable by the BCP 101. In an embodiment, the sending module 221 may be configured for sending the data file to the BCP 101 for printing.

In an embodiment, the receiving module 267 in the MFP 103 receives the command file 261 to be converted in a format understandable by BCP 101. For example, the formats not recognizable by BCP 101 are at least one of Page Description Language (PDL) format, Printer Control Language (PCL) format, PostScript (PS), XML Paper Specification (XPS) or Portable Document Format (PDF) format.

In an embodiment, the converting module 269 converts the command file 261 to a format understandable by the BCP 101. As mentioned above, if the BCP 101 receives the command file in a format not recognizable by BCP 101, the command file 261 can be converted by the MFP 103. The creating module 219 creates a data file 111 in a predefined image file format understandable by the BCP 101. For example, the predefined image file format can be Bitmap (BMP) image file format.

In an embodiment, the sending module 271 sends the data file 111 converted by MFP 103 to the BCP 101 using a predetermined communication channel 107. For example, the predetermined communication channel 107 can be a wired or a wireless connection.

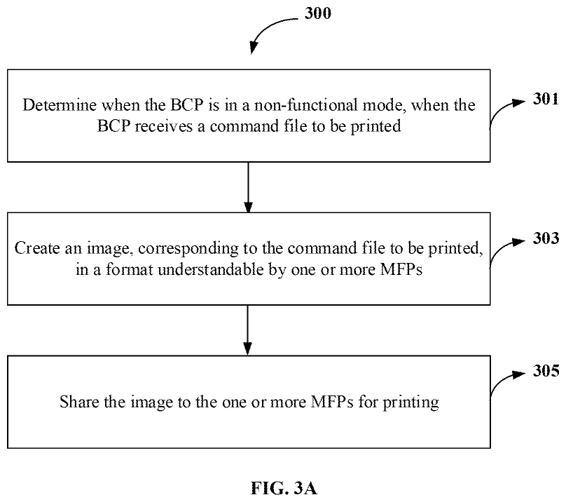

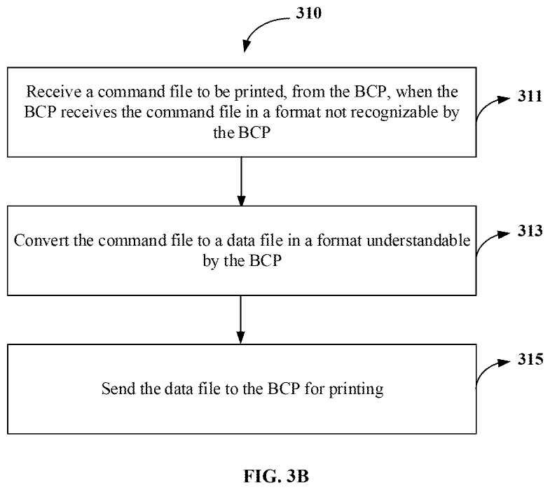

FIG. 3A shows a flowchart illustrating a method for linking Multi-Function Printers (MFPs) and Bar-Code Printers (BCPs), in accordance with some embodiments of the present disclosure.

As illustrated in FIG. 3, the method 300 may include one or more blocks illustrating a method for linking Multi-Function Printers and Bar-Code Printer (BCP) 101. The method 300 may be described in the general context of computer executable instructions. Generally, computer executable instructions can include routines, programs, objects, components, data structures, procedures, modules, and functions, which perform specific functions or implement specific abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 301, the method 300 includes determining, by the BCP 101, when the BCP 101 is in a non-functional mode, when the BCP 101 receives a command file 102 to be printed. In an embodiment, the non-functional mode can be at least one of a paper out condition, a ribbon out condition and a print head error.

At block 303, the method 300 includes creating, by the BCP 101, corresponding to the command file 102 to be printed, in a predefined image file format understandable by one or more MFPs 103. For example, the predefined image file format understandable by MFP 103 is Bitmap (BMP) image file format.

At block 305, the method 300 includes sharing, by the BCP 101, the image 105 to the one or more MFPs 103 for printing. In an embodiment, the MFP 103 and BCP 101 are connected using a predetermined communication channel 107.

FIG. 3B shows a flowchart illustrating a method for linking Multi-Function Printers (MFPs) and Bar-Code Printers (BCPs), in accordance with some embodiments of the present disclosure.

As illustrated in FIG. 3B, the method 310 may include one or more blocks illustrating a method for linking Bar-Code Printer (BCP) 101 and Multi-Function Printer (MFP) 103. The method 310 may be described in the general context of computer executable instructions. Generally, computer executable instructions can include routines, programs, objects, components, data structures, procedures, modules, and functions, which perform specific functions or implement specific abstract data types.

The order in which the method 310 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 311, the method 310 includes receiving, by the MFP 103, a command file 102 to be printed, from the BCP 101, when the BCP 101 receives the command file 102 in a format not recognizable by the BCP 101. For example, the format can be at least one of Page Description Language (PDL) format, Printer Control Language (PCL) format, PostScript (PS), XML Paper Specification (XPS) or Portable Document Format (PDF) format.

At block 313, the method 310 includes converting, by the MFP 103, the command file 102 to a data file 111 in a predefined image file format understandable by the BCP 101. For example, the predefined image file format understandable by MFP 103 is Bitmap (BMP) image file format.

At block 315, the method 310 includes sending, by the MFP 103, the data file 111 to the BCP 101 for printing. In an embodiment, the MFP 103 and BCP 101 are connected using a predetermined communication channel 107.

### Computer System

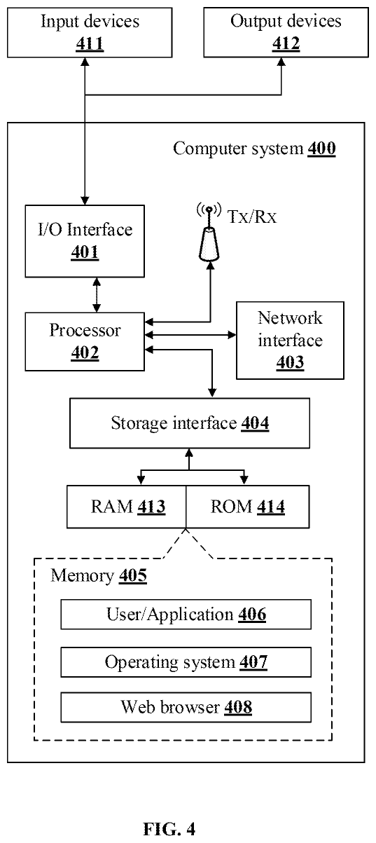

FIG. 4 illustrates a block diagram of an exemplary computer system 400 for implementing embodiments consistent with the present disclosure. In an embodiment, the computer system 400 may be the BCP 102 and/or the MFP 103. The computer system 400 may include a central processing unit (“CPU” or “processor” or “memory controller”) 402. The processor 402 may comprise at least one data processor for executing program components for executing user- or system-generated business processes. A user may include an application developer, a programmer, a user of the BCP 102 or the MFP 103, an organization or any system/sub-system being operated parallelly to the computer system 400. The processor 402 may include specialized processing units such as integrated system (bus) controllers, memory controllers/memory management control units, floating point units, graphics processing units, digital signal processing units, etc.

The processor 402 may be disposed in communication with one or more Input/Output (I/O) devices (411 and 412) via I/O interface 401. The I/O interface 401 may employ communication protocols/methods such as, without limitation, audio, analog, digital, stereo, IEEE®-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE® 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface 401, the computer system 400 may communicate with one or more I/O devices 411 and 412.

In some embodiments, the processor 402 may be disposed in communication with a preferred network via a network interface 403. The network interface 403 may communicate with the preferred network. The network interface 403 may employ connection protocols including, without limitation, direct connect, Ethernet (e.g., twisted pair 10/100/1000 Base T), Transmission Control Protocol/Internet Protocol (TCP/IP), token ring, IEEE® 802.11a/b/g/n/x, etc.

In some embodiments, the processor 402 may be disposed in communication with a memory 405 (e.g., RAM 413, ROM 414, etc. as shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user/application interface 406, an operating system 407, a web browser 408, and the like. In some embodiments, computer system 400 may store user/application data 406, such as the data, variables, records, etc. as described in the present disclosure. Such databases may be implemented as fault-tolerant, relational, scalable, secure databases such as Oracle® or Sybase®.

The operating system 407 may facilitate resource management and operation of the computer system 400. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM® OS/2®, MICROSOFT® WINDOWS® (XP®, VISTA®/7/8, 10 etc.), APPLE® IOS®, GOOGLE™ ANDROID™, BLACKBERRY® OS, or the like.

The user interface 406 may facilitate display, execution, interaction, manipulation, or operation of program components through textual or graphical facilities. For example, the user interface 406 may provide computer interaction interface elements on a display system operatively connected to the computer system 400, such as cursors, icons, check boxes, menus, scrollers, windows, widgets, and the like. Further, Graphical User Interfaces (GUIs) may be employed, including, without limitation, APPLE® MACINTOSH® operating systems' Aqua®, IBM® OS/2®, MICROSOFT® WINDOWS® (e.g., Aero, Metro, etc.), web interface libraries (e.g., ActiveX®, JAVA®, JAVASCRIPT®, AJAX, HTML, ADOBE® FLASH®, etc.), or the like.

The web browser 408 may be a hypertext viewing application. Secure web browsing may be provided using Secure Hypertext Transport Protocol (HTTPS), Secure Sockets Layer (SSL), Transport Layer Security (TLS), and the like. The web browsers 408 may utilize facilities such as AJAX, DHTML, ADOBE® FLASH®, JAVASCRIPT®, JAVA®, Application Programming Interfaces (APIs), and the like. Further, the computer system 400 may implement a mail server stored program component. The mail server may utilize facilities such as ASP, ACTIVEX®, ANSI® C++/C #, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 400 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, and the like.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Advantages of the embodiments of the present disclosure are illustrated herein.

In an embodiment, the present disclosure links the functionalities of the Multi-Function Printers (MFPs) and the Bar-Code Printer (BCPs) and ensures that the barcodes may be printed even when the BCP is in a non-functional mode or when the BCP receives a command file that is not in the format understandable by the BCP.

In an embodiment, the proposed method allows users to print the label images, which are usually printed in the BCP, using the MFP when the BCP is not available and/or non-functional.

As stated above, it shall be noted that the method of the present disclosure may be used to overcome various technical problems related to printing barcodes when the BCP is non-functional. In other words, the disclosed method has a practical application and provides a technically advanced solution to the technical problems associated with the BCPs.

In light of the technical advancements provided by the disclosed method, the claimed steps, as discussed above, are not routine, conventional, or well-known aspects in the art, as the claimed steps provide the aforesaid solutions to the technical problems existing in the conventional technologies. Further, the claimed steps clearly bring an improvement in the functioning of the system itself, as the claimed steps provide a technical solution to a technical problem.

The terms “an embodiment”, “embodiment”, “embodiments”, “the embodiment”, “the embodiments”, “one or more embodiments”, “some embodiments”, and “one embodiment” mean “one or more (but not all) embodiments of the present disclosure” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the present disclosure.

When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article or a different number of devices/articles may be used instead of the shown number of devices or programs. The functionality and/or features of a device may be alternatively embodied by one or more other devices which are not explicitly described as having such functionality/features. Thus, other embodiments of the present disclosure need not include the device itself.

Finally, the language used in the specification has been principally selected for readability and instructional purposes, and it may not have been selected to delineate or circumscribe the inventive subject matter. It is therefore intended that the scope of the present disclosure be limited not by this detailed description, but rather by any claims that issue on an application based here on. Accordingly, the embodiments of the present disclosure are intended to be illustrative, but not limiting, of the scope of the present disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERENCE NUMERALS

| Reference Number | Description |
|---|---|
| 101 | Bar-Code Printer |
| 102 | Command file |
| 103 | Multi-function Printer |
| 105 | Image |
| 107 | Communication channel |
| 111 | Data file |
| 201 | I/O Interface of Bar-Code Printer |
| 203 | Processor of Bar-Code Printer |
| 205 | Memory of Bar-Code Printer |
| 207 | Data of Bar-Code Printer |
| 209 | Modules of Bar-Code Printer |
| 211 | Command file |
| 213 | Image |
| 215 | Other data |
| 217 | Determining module |
| 219 | Creating module |
| 221 | Sharing module |
| 223 | Other modules |
| 251 | I/O Interface of Multi-Function Printer |
| 253 | Processor of Multi-Function Printer |
| 255 | Memory of Multi-Function Printer |
| 257 | Data of Multi-Function Printer |
| 259 | Modules of Multi-Function Printer |
| 261 | Command file |
| 263 | Data file |
| 265 | Other data |
| 267 | Receiving module |
| 269 | Converting module |
| 271 | Sending module |
| 273 | Other modules |
| 400 | Exemplary computer system |
| 401 | I/O Interface of the exemplary computer system |
| 402 | Processor of the exemplary computer system |
| 403 | Network interface |
| 404 | Storage interface |
| 405 | Memory of the exemplary computer system |
| 406 | User/Application |
| 407 | Operating system |
| 408 | Web browser |
| 411 | Input devices |
| 412 | Output devices |
| 413 | RAM |
| 414 | ROM |

1. A method for linking Multi-Function Printers (MFPs) and Bar-Code Printers (BCPs), the method comprising:
receiving, by a BCP, a command file to be printed;
determining, by the BCP, whether the BCP is in a non-functional mode;
creating, by the BCP, an image in a format understandable by a MFP that corresponds to the command file to be printed; and
transmitting, by the BCP, the image to the MFP for printing.

2. The method as claimed in claim 1, wherein the BCP is determined to be in the non-functional mode based on at least one of a paper out condition, a ribbon out condition, or a print head error.

3. The method as claimed in claim 1, wherein the format understandable by the MFP is a predefined image file format.

4. The method as claimed in claim 1, wherein the MFP and the BCP are connected using a predetermined communication channel.

5. A method for linking Multi-Function Printers (MFPs) and Bar-Code Printers (BCPs), the method comprising:
receiving, by a MFP from a BCP, a command file to be printed when the BCP receives the command file in a first format not recognizable by the BCP;
converting, by the MFP, the command file to a data file in a second format understandable by the BCP; and
transmitting, by the MFP, the data file to the BCP for printing.

6. The method as claimed in claim 5, wherein the command file is not recognizable by the BCP when the first format of the command file is at least one of a Page Description Language (PDL) format, a Printer Control Language (PCL) format, a PostScript (PS), a XML Paper Specification (XPS), or a Portable Document Format (PDF) format.

7. The method as claimed in claim 5, wherein the second format understandable by the BCP is a predefined image file format.

8. The method as claimed in claim 5, wherein the MFP and the BCP are connected using a predetermined communication channel.

9. A Bar-Code Printer (BCP) comprising:
a processor; and
a memory, communicatively coupled to the processor, wherein the memory is configured to store processor-executable instructions, which, on execution, causes the processor to:
receive a command file to be printed;
determine whether the BCP is in a non-functional mode;
create an image corresponding to the command file to be printed in a format understandable by a Multi-Function Printer (MFP); and
transmit the image to the MFP for printing.

10. The BCP as claimed in claim 9, wherein the BCP is determined to be in the non-functional mode based on at least one of a paper out condition, a ribbon out condition, or a print head error.

11. The BCP as claimed in claim 9, wherein the format understandable by the MFP is a predefined image file format.

12. The BCP as claimed in claim 9, wherein the MFP and the BCP are connected using a predetermined communication channel.

13. A Multi-Function Printer (MFP) comprising:
a processor; and
a memory, communicatively coupled to the processor, wherein the memory is configured to store processor-executable instructions, which, on execution, causes the processor to:
receive a command file to be printed from a Bar-Code Printer (BCP) when the BCP receives the command file in a first format not recognizable by the BCP;
convert the command file to a data file in a second format understandable by the BCP; and
transmit the data file to the BCP for printing.

14. The MFP as claimed in claim 13, wherein the command file is not recognizable by the BCP when the first format of the command file is at least one of a Page Description Language (PDL) format, a Printer Control Language (PCL) format, a PostScript (PS), a XML Paper Specification (XPS), or a Portable Document Format (PDF) format.

15. The MFP as claimed in claim 13, wherein the second format understandable by the BCP is a predefined image file format.

16. The MFP as claimed in claim 13, wherein the MFP and the BCP are connected using a predetermined communication channel.

17. A non-transitory computer readable medium comprising instructions stored thereon that, when executed by at least one processor, cause a Bar-Code Printer (BCP) to:
receive a command file to be printed;
determine whether the BCP is in a non-functional mode
create an image corresponding to the command file to be printed in a format understandable by a Multi-Function Printer (MFP); and
transmit the image to the MFP for printing.

18. The non-transitory computer readable medium as claimed in claim 17, wherein the BCP is determined to be in the non-functional mode based on at least one of a paper out condition, a ribbon out condition, or a print head error.

19. The non-transitory computer readable medium as claimed in claim 17, wherein the format understandable by the MFP is a predefined image file format.

20. The non-transitory computer readable medium as claimed in claim 17, wherein the MFP and the BCP are connected using a predetermined communication channel.

21. A non-transitory computer readable medium comprising instructions stored thereon that when executed by at least one processor, cause a Multi-Function Printer (MFP) to:
receive a command file to be printed from a Bar-Code Printer (BCP) when the BCP receives the command file in a first format not recognizable by the BCP;
convert the command file to a data file in a second format understandable by the BCP; and
transmit the data file to the BCP for printing.

22. The non-transitory computer readable medium as claimed in claim 21, wherein the command file is not recognizable by the BCP when the first file format of the command file is at least one of a Page Description Language (PDL) format, a Printer Control Language (PCL) format, a PostScript (PS), a XML Paper Specification (XPS), or a Portable Document Format (PDF) format.

23. The non-transitory computer readable medium as claimed in claim 21, wherein the second format understandable by the BCP is a predefined image file format.

24. The non-transitory computer readable medium as claimed in claim 21, wherein the MFP and the BCP are connected using a predetermined communication channel.
